(19) United States
(12) Patent Application Publication
(10) Pub. No.: US 2011/0051756 A1
(43) Pub. Date: Mar. 3, 2011

(54) BEAM IRRADIATION APPARATUS

(75) Inventors: Takaaki Morimoto, Anpachi-Gun (JP); Masato Yamada, Inuyama-City (JP); Yoshiaki Maeno, Mizuho-City (JP)

(73) Assignee: SANYO Electric Co., Ltd., Moriguchi-shi (JP)

(21) Appl. No.: 12/869,333

(22) Filed: Aug. 26, 2010

(30) Foreign Application Priority Data
Aug. 27, 2009 (JP) 2009-197473

(51) Int. Cl. H01S 3/10

(52) U.S. Cl. 372/24

(57) ABSTRACT

A beam irradiation apparatus includes a light source which outputs a laser beam, a convergent lens into which the laser beam output from the light source is entered, and a scanning portion which makes the laser beam transmitted through the convergent lens scan on a target region. In the beam irradiation apparatus, the laser light source is arranged such that a pn junction surface of a laser chip is parallel with the vertical direction. Further, length of the laser beam in the vertical direction on the target region is set by length of a light emitting portion of the laser light source in the vertical direction.

This application claims priority under 35 U.S.C. Section 119 of Japanese Patent Application No. 2009-197473 filed Aug. 27, 2009, entitled “BEAM IRRADIATION APPARATUS”. The disclosure of the above application is incorporated herein by reference.

### BACKGROUND OF THE INVENTION

1. Field of the Invention

The present invention relates to a beam irradiation apparatus which irradiates a target region with light, particularly relates to a beam irradiation apparatus which is suitably mounted on a laser radar.

2. Related Art

In recent years, a laser radar is mounted on a household automobile or the like in order to enhance safety while driving. In general, the laser radar makes a laser beam scan within a target region and detects presence/absence of an obstacle at each scanning position based on presence/absence of reflected light from each scanning position. Further, a distance to the obstacle is detected based on a time needed from an irradiation timing of a laser beam at each scanning position to a reception timing of reflected light.

A beam irradiation apparatus for making a laser beam scan on a target region is incorporated into the laser radar. In a case where the laser radar is mounted on an automobile, detection accuracy in the horizontal direction is improved in comparison with that in the vertical direction. Therefore, the beam irradiation apparatus mounted on the laser radar of such type irradiates the target region with a beam having a shape which is longer in the vertical direction and narrower in the horizontal direction.

When a laser diode is used as a light source of the beam irradiation apparatus, a divergence angle of an output laser beam is large in the direction perpendicular to a pn junction surface (hereinafter, referred to “short side direction”) and is small in the direction parallel with the pn junction surface (hereinafter, referred to “longitudinal direction”). Therefore, when the laser diode is used as the light source of the beam irradiation apparatus, a configuration for adjusting a shape of a beam on the target region to a desired shape is needed. In this case, a beam shaping lens such as a cylindrical lens may be used in addition to a convergent lens.

However, if the beam shaping lens such as the cylindrical lens is needed in addition to the convergent lens as described above, a problem that the number of parts and cost are increased arises. Further, a problem that a shape of the beam on the target region is distorted because of an aberration caused by the cylindrical lens or the like may also arise.

### SUMMARY OF THE INVENTION

A beam irradiation apparatus according to a first aspect of the invention includes a light source which outputs a laser beam, a convergent lens into which the laser beam output from the light source is entered, and a scanning portion which makes the laser beam transmitted through the convergent lens scan on a target region. In the beam irradiation apparatus, the laser light source is arranged such that a pn junction surface of a laser chip is parallel with the vertical direction. Further, length of the laser beam in the vertical direction on the target region is set by length of a light emitting portion of the laser light source in the vertical direction.

A beam irradiation apparatus according to a second aspect of the invention includes a light source in which a plurality of laser chips is arranged so as to be aligned in the vertical direction such that pn junction surfaces are parallel with the vertical direction, a convergent lens into which the laser beam output from the light source is entered, a scanning portion which makes the laser beam transmitted through the convergent lens scan on a target region and a light source controller which controls the light source. The light source controller makes all of the plurality of laser chips emit light simultaneously when the target region is irradiated with the laser light.

### BRIEF DESCRIPTION OF THE DRAWINGS

The above-described and other objects and novel characteristics of the invention are made obvious more perfectly by reading the following description of embodiment and the following accompanying drawings.

FIG. 1 is a view illustrating a mounting form of a beam irradiation apparatus according to an embodiment.

FIGS. 2A through 2D are views for explaining a method of configuring a laser light source according to the embodiment.

FIGS. 3A through 3D are views for explaining a method of configuring the laser light source according to the embodiment.

FIGS. 4A through 4D are views for explaining a method of configuring the laser light source according to the embodiment.

FIG. 5 is an exploded perspective view illustrating a configuration of a mirror actuator according to the embodiment.

FIGS. 6A and 6B are perspective views illustrating a configuration of the mirror actuator according to the embodiment.

FIG. 7A is a view illustrating a configuration of an optical system of the beam irradiation apparatus according to the embodiment. FIG. 7B is a view illustrating an arrangement of a laser chip of the beam irradiation apparatus according to the embodiment.

FIGS. 8A and 8B are views illustrating a configuration of the optical system of the beam irradiation apparatus according to the embodiment.

FIG. 9 is a diagram illustrating a configuration of a laser radar according to the embodiment.

It is to be noted that the drawings are exclusively intended to explain the invention only and are not intended to limit a range of the invention.

### DESCRIPTION OF PREFERRED EMBODIMENTS

Hereinafter, an embodiment of the invention will be described with reference to drawings. Note that a beam irradiation apparatus according to the invention is mounted on a laser radar for an automobile.

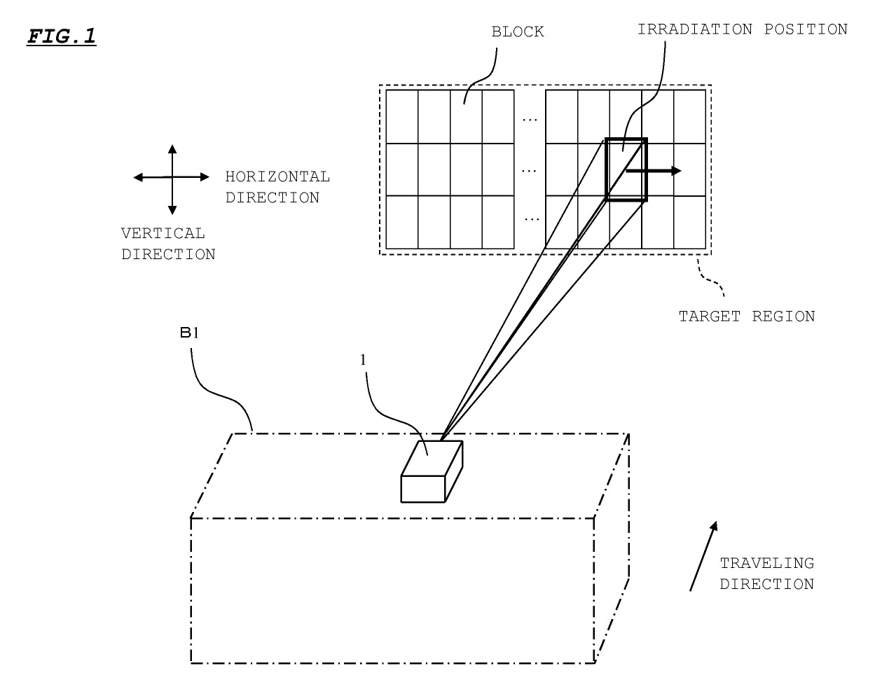

FIG. 1 is a view illustrating a mounting form of the beam irradiation apparatus according to the embodiment.

As shown in FIG. 1, a beam irradiation apparatus 1 is arranged at a front side of an automobile B1 and irradiates a target region set at a front side in a traveling direction with a laser beam. Irradiation blocks of three stages in the vertical direction are set as the target region. Each block has an elongated shape in the vertical direction. The laser beam output from the beam irradiation apparatus 1 sequentially scans each block on the target region row by row in the horizontal direction from left to right, for example. As shown in FIG. 1, the irradiation region of the laser beam on the target region is set to be slightly larger than each block. The beam irradiation apparatus 1 pulse-emits the laser beam at a timing where a scanning position corresponds to a position of each block.

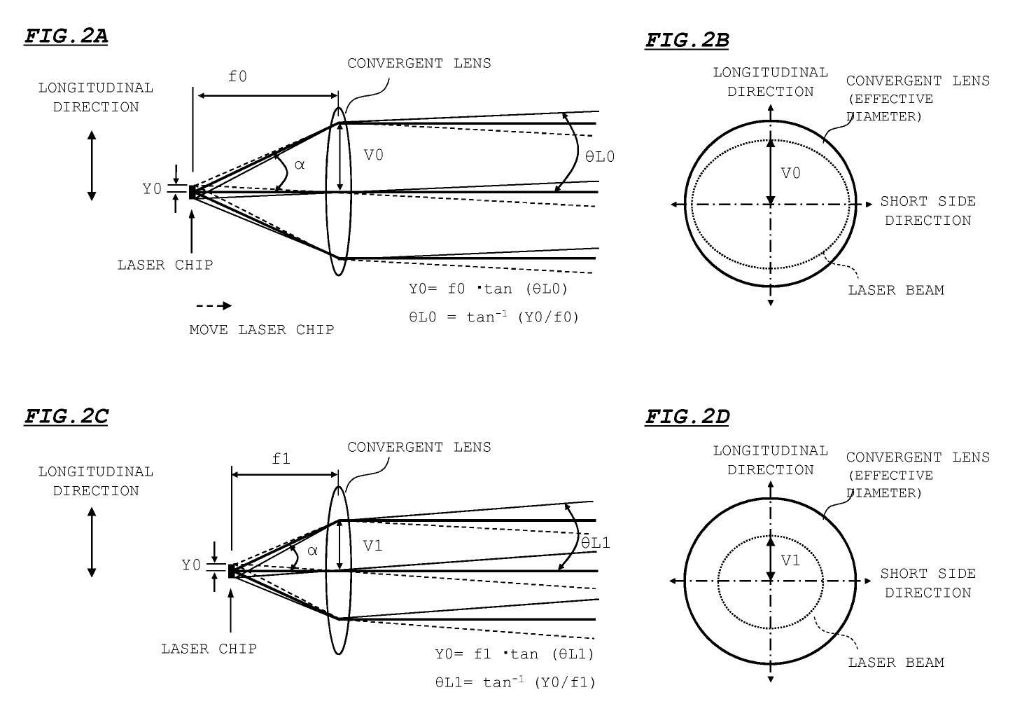

FIGS. 2A through 2D are views for explaining a method of configuring a laser light source in the beam irradiation apparatus 1. In FIGS. 2A through 2D, a convergent lens is a convex lens having a predetermined focal distance. A lens surface of the convergent lens has a rotational symmetrical shape about an optical axis.

If a laser chip of the laser light source (laser diode) is arranged at a focal position of the convergent lens as shown in FIG. 2A, the following relationship is established among a divergence angle θL0 of a laser beam in the longitudinal direction (the direction parallel with a pn junction surface) after the laser beam transmits through the convergent lens, a half value Y0 of length of the laser chip in the longitudinal direction (length of a light emitting portion) and a focal distance f0 of the convergent lens. It is to be noted that the following relational expressions are satisfied when the divergence angle θL0 is a value close to zero.

Y0=f0·tan(θL0) (1)

θL0=tan⁻¹(Y0/f0) (2)

In this case, the divergence angle of the laser beam in the short side direction (the direction perpendicular to a pn junction surface) after the laser beam transmits through the convergent lens is zero. That is to say, the laser beam which is output so as to be spread in the short side direction transmits through the convergent lens, and then, travels parallel with the optical axis. In this case, the laser beam enters into the lens as shown in FIG. 1B, for example.

With the above expressions (1) and (2), if the laser chip is arranged on the focal position of the convergent lens, the laser beam has a predetermined divergence angle θL0 in the longitudinal direction. Therefore, the laser chip is desired to be arranged such that the longitudinal direction is in parallel with the vertical direction in order to make the laser beam on the target region have an elongated shape in the vertical direction as shown in FIG. 1C. With this, the length of the laser beam in the vertical direction on the target region can be set to a desired length by adjusting the half value Y0 of the length of the laser chip in the longitudinal direction (vertical direction) or the focal distance f0 of the lens.

In this case, a width of the laser beam in the horizontal direction on the target region can be adjusted by moving the position of the laser chip from the position as shown in FIG. 2A toward the convergent lens as shown by a dashed-line arrow as shown in FIG. 2A. Here, the position as shown in FIG. 2A indicates a position of the focal distance f0 of the convergent lens. That is to say, if the position of the laser chip is made close to the convergent lens from the focal position of the convergent lens, the divergence angle θs0 of the laser beam in the short side direction (horizontal direction) after the laser beam transmits through the convergent lens can be obtained by the following expression.

θs0=λ/(πω) (3)

In the expression, λ indicates a wavelength of the laser beam and ω indicates a radius of beam waist at a virtual image position. Note that the expression is satisfied when the width of the laser chip in the short side direction is small and the laser chip is regarded as a point light source.

With the above expression (3), the width of the laser light in the horizontal direction on the target region can be set to a desired width by making the position of the laser chip close to the convergent lens from the focal position of the convergent lens and adjusting the divergence angle θs0 in the short side direction (horizontal direction).

In this case, the divergence angle θs0 can be set to a desired value by slightly moving the position of the laser chip from the position of the focal distance of the convergent lens. Therefore, the divergence angle θL0 of the laser beam in the longitudinal direction (vertical direction) as shown in FIG. 2A is not so different from that in a case where the laser chip is at the position of the focal distance even when the position of the laser chip is moved in such a manner. Accordingly, the length of the laser beam in the vertical direction on the target region can be kept to be a desired length even if the position of the laser chip is moved in order to adjust the divergence angle θs0 in the short side direction (horizontal direction).

The shape of the laser beam on the target region can be made an elongated shape in the vertical direction by arranging the laser chip such that the longitudinal direction is in parallel with the vertical direction as described above. Further, with the above expressions (1) and (2), the length of the laser beam in the vertical direction on the target region can be set to a desired length by adjusting the half value Y0 of the length of the laser chip in the longitudinal direction (vertical direction) or the focal distance f0 of the lens.

For example, the divergence angle of a laser beam after the laser beam passes through the convergent lens can be enlarged from θL0 to θL1 by making the focal distance of the convergent lens short from f0 to f1 as shown in FIG. 2C. However, in this case, a beam diameter of the laser beam when the laser beam is entered into the convergent lens is made smaller as shown FIG. 2D. If the beam diameter is made small in such a manner, the laser beam is easily affected by dusts, water drops, or the like adhering to the convergent lens. Therefore, there is a risk that the target region cannot be appropriately irradiated with the laser beam.

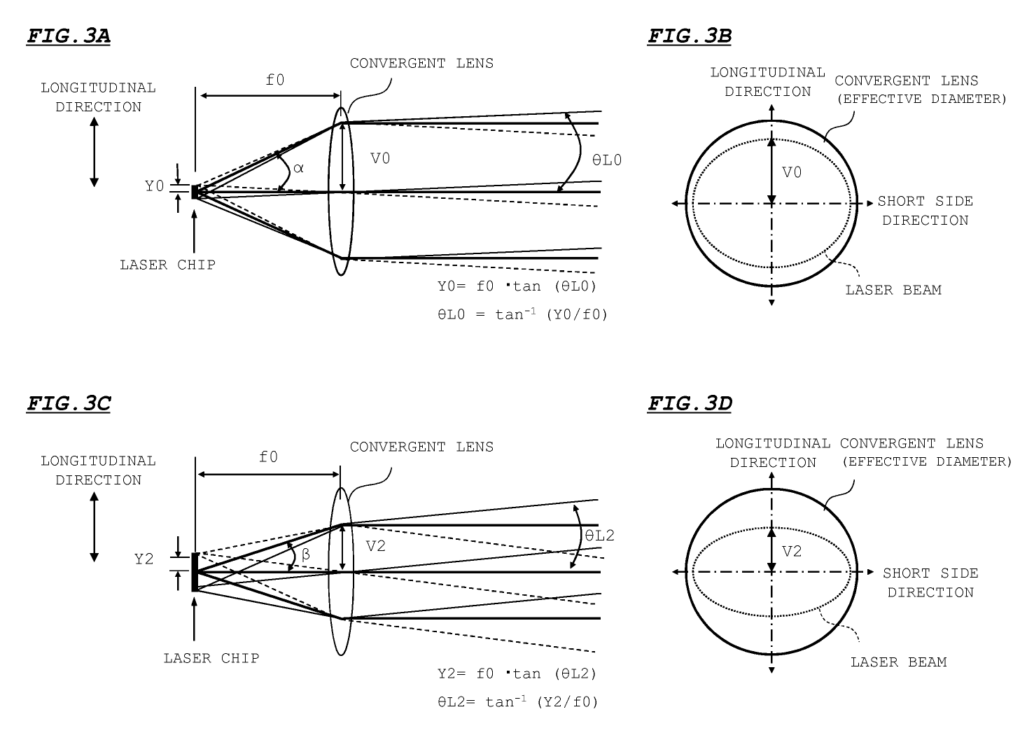

Further, the divergence angle of a laser beam after the laser beam passes through the convergent lens can be enlarged from θL0 to θL2 by making the half value of length of the laser chip in the longitudinal direction (vertical direction) large from Y0 to Y2 as shown in FIG. 3C. In FIGS. 3A and 3B, the same views as those as shown in FIGS. 2A and 2B are illustrated for comparison. However, with a configuration as shown in FIG. 3C, a divergence angle β of a laser beam in the longitudinal direction when the laser beam is output from the laser chip is made smaller than a divergence angle α in the case of FIG. 3A. Therefore, in this case, as shown in FIG. 3D, a beam diameter of the laser beam when the laser beam is entered into the convergence lens is also smaller than that in the case of FIGS. 3A and 3B.

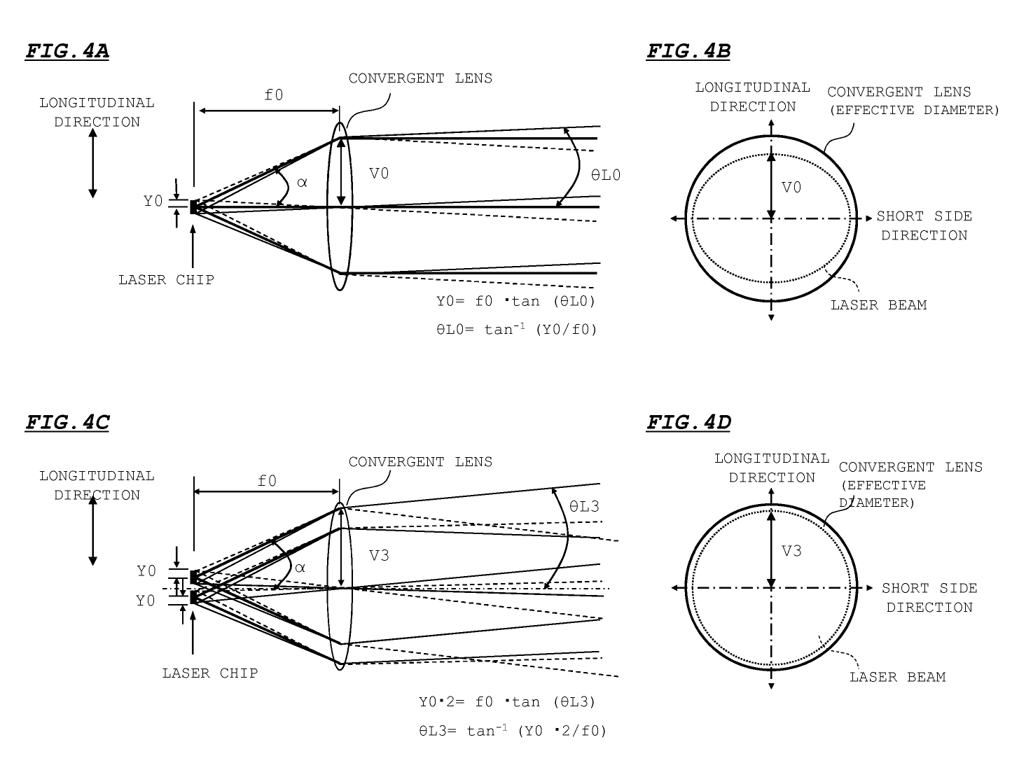

Problems arising with configurations as shown in FIGS. 2C and 3C can be solved by employing a configuration as shown in FIG. 4C. In FIGS. 4A and 4B, the same views as those as shown in FIGS. 2A and 2B are illustrated for comparison.

In the configuration as shown in FIG. 4C, two laser chips are arranged so as to be aligned in the longitudinal direction (vertical direction) such that pn junction surfaces are parallel with the longitudinal direction (vertical direction). In such a manner, the half value of the entire length of the laser chips (light emitting portion) in the longitudinal direction (vertical direction) are made large from Y0 to 2·Y0. Therefore, the divergence angle of the laser beam after the laser beam passes through the convergence lens is enlarged from θL0 to θL3. In this case, a divergence angle α of the laser beam when the leaser beam is output from each laser chip is the same as that in FIG. 4A. Therefore, as shown in FIG. 4D, a beam diameter of the laser beam when the laser beam is entered into the convergence lens is larger than that in the case of FIGS. 4A and 4B.

As described above, the laser chip is desired to be arranged such that the longitudinal direction is in parallel with the vertical direction in order to irradiate the target region with a laser beam having an elongated shape in the vertical direction. In this case, the following method is desired to be employed in order to adjust length of the laser light on the target region in the vertical direction. That is, a plurality of laser chips is arranged so as to be aligned in the longitudinal direction (vertical direction) such that pn junction surfaces are parallel with the longitudinal direction (vertical direction). With this configuration, the length of each laser chip in the longitudinal direction and the number of the laser chips arranged in the longitudinal direction are appropriately adjusted in accordance with the length of the laser beam in the vertical direction on the target region. Therefore, the target region can be irradiated with a laser beam having a desired shape while keeping the beam diameter of the laser beam when the laser beam is entered into the convergent lens to be large.

### Specific Configuration Example

Hereinafter, a specific configuration example of the beam irradiation apparatus according to the embodiment is described.

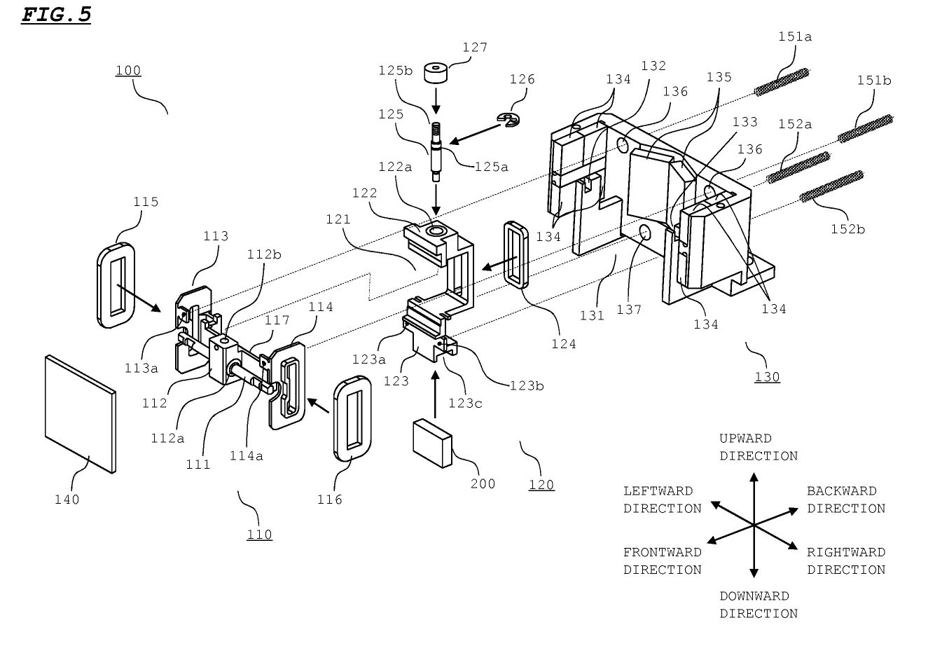

At first, a configuration of a mirror actuator 100 for making a laser beam scan on a target region is described with reference to FIG. 5.

In FIG. 5, a reference numeral 110 corresponds to a tilt unit. The tilt unit 110 includes a supporting shaft 111, a bearing portion 112, coil supporting plates 113, 114, coils 115, 116 and a connecting portion 117. The bearing portion 112 is rotatably attached to the supporting shaft 111. The coil supporting plates 113, 114 are arranged at positions so as to be symmetric with respect to the bearing portion 112. The coils 115, 116 are attached to the coil supporting plates 113, 114, respectively. The connecting portion 117 connects the bearing portion 112 and the coil supporting plates 113, 114.

A shaft hole 112a penetrating through in the left-right direction is provided on the bearing portion 112. The supporting shaft 111 is put through the shaft hole 112a. The bearing portion 112 is attached to a center portion of the supporting shaft 111. Further, a hole 112b is provided on an upper face of the bearing portion 112.

Flange portions projecting in the left-right direction are formed on the upper side faces of the coil supporting plates 113, 114. Holding holes 113a, 114a are provided on the respective flange portions. The holding holes 113a, 114a are provided at positions so as to be symmetric with respect to the bearing portion 112. Positions of the holding holes 113a, 114a in the up-down direction and front-rear direction are the same as each other.

Coils 115, 116 each of which is wound into a square form are attached to the coil supporting plates 113, 114, respectively. An output terminal of the coil 115 is connected to an input terminal of the coil 116 with a signal line (not shown).

A reference numeral 120 corresponds to a pan unit. The pan unit 120 includes a recess 121, a bearing portion 122, a reception portion 123, a coil 124, a supporting shaft 125, an E ring 126 and a balancer 127. The recess 121 accommodates the tilt unit 110. The bearing portion 122 is continuously connected to an upper portion of the recess 121. The reception portion 123 is continuously connected to a lower portion of the recess 121. The coil 124 is attached to a rear face of the recess 121.

A shaft hole 122a penetrating through in the up-down direction is provided on the bearing portion 122. As described later, the supporting shaft 125 is put through the shaft hole 122a in the up-down direction when the tilt unit 110 and the pan unit 120 are assembled. As shown in FIG. 5, a groove 125a with which the E ring 126 is fastened is formed on the supporting shaft 125. A thread groove 125b to which the balancer 127 is attached is formed on an upper portion of the supporting shaft 125.

Holding holes 123a, 123b are provided on the reception portion 123. The holding holes 123a, 123b are provided at positions so as to be symmetric with respect to the supporting shaft 125. Positions of the holding holes 123a, 123b in the up-down direction and the front-rear direction are the same as each other. A recess 123c is formed on a lower edge of the reception portion 123. A gap of the recess 123c in the front-rear direction has substantially the same dimension as the thickness of a transparent body 200. An upper portion of the transparent body 200 is attached to the recess 123c.

A coil attachment portion (not shown) is formed on a rear face of the pan unit 120. A coil 124 which is wound into a square form is attached to the coil attachment portion.

A reference numeral 130 corresponds to a magnet unit. The magnet unit 130 includes a recess 131, grooves 132, 133, eight magnets 134 and two magnets 135. The recess 131 accommodates the pan unit 120. The grooves 132, 133 engage with both edges of the supporting shaft 111. The eight magnets 134 apply magnetic fields to the coils 115, 116. The two magnets 135 apply a magnetic field to the coil 124.

The eight magnets 134 are attached to left and right inner side faces of the recess 131 so as to be divided into two stages of the upper side and the lower side. Further, the two magnets 135 are attached to the inner side faces of the recess 131 so as to be inclined in the front-rear direction as shown in FIG. 5. Further, holes 136, 137 to which power supply springs 151a, 151b, 152a, 152b are inserted are formed on the recess 131.

When the mirror actuator 100 is assembled, the tilt unit 110 is assembled, at first. That is to say, the supporting shaft 111 is attached to the shaft hole 112a and the coils 115, 116 are attached to the coil supporting plates 113, 114, respectively.

Thereafter, the assembled tilt unit 110 is accommodated in the recess 121 of the pan unit 120. Then, the supporting shaft 125 is inserted from the upper side in a state where the hole 112b of the tilt unit 110 and the shaft hole 122a of the pan unit 120 are matched with each other in the up-down direction. A lower edge of the supporting shaft 125 is fixed to the hole 112b. Then, the E ring 126 is fastened to the groove 125a so that the supporting shaft 125 does not move downwardly from a position at which the E ring 126 is fastened with respect to the pan unit 120. Thus, the pan unit 120 is rotatably supported with respect to the tilt unit 110 by the supporting shaft 125.

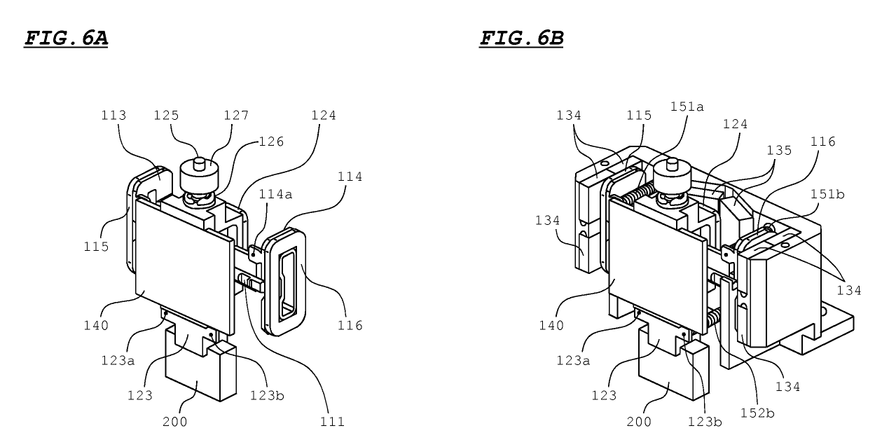

Thereafter, the balancer 127 is fastened to the thread groove 125b of the supporting shaft 125. Further, the transparent body 200 is attached to the recess 123c. A mirror 140 is attached to a front face of the pan unit 120. Thus, the tilt unit 110, the pan unit 120 and the mirror 140 are completely assembled as shown in FIG. 6A.

Note that the balancer 127 is a portion for adjusting the constituent components of the mirror actuator 100 which rotates about the supporting shaft 111 so as to rotate in a balanced manner when the constituent components of the mirror actuator 100 rotates about the supporting shaft 111. The balance of such rotation is adjusted by weight of the balancer 127. In addition, a position of the balancer 127 in the up-down direction is fine-adjusted by the thread groove 125b of the supporting shaft 125 so that the balance of the rotation is adjusted.

Thereafter, a configured body as shown in FIG. 6A is attached to the magnet unit 130.

Returning to FIG. 5, both edges of the supporting shaft 111 are fixed to the grooves 132, 133 of the magnet unit 130, from the upper side. Engagement portions which engage with the grooves 132, 133, are formed on the both edges of the supporting shaft 111. When these engagement portions are fitted into the grooves 132, 133, the supporting shaft 111 is fixed to the grooves 132, 133 without rotating.

Subsequently, the power supply springs 151a, 151b, 152a, 152b are put through the holes 136, 137 from the rear face side of the recess 131. In this case, distal edges of the power supply springs 151a, 151b are locked by the holding holes 113a, 114a of the tilt unit 110. Further, the distal edges of the locked power supply springs 151a, 151b are electrically connected to the input terminal of the coil 115 and the output terminal of the coil 116, respectively, with solders or the like. Rear edges of the power supply springs 151a, 151b are locked by the holding holes provided on the rear face side of the magnet unit 130.

On the other hand, distal edges of the power supply springs 152a, 152b are locked by the holding holes 123a, 123b of the pan unit 120, respectively. Further, the distal edges of the locked power supply springs 152a, 152b are electrically connected to an input terminal and an output terminal of the coil 124, respectively, with solders or the like. Rear edges of the power supply springs 152a, 152b are locked by the holding holes provided on the rear face side of the magnet unit 130.

When an interconnect substrate is arranged on the rear face of the magnet unit 130, the rear edges of the power supply springs 151a, 151b, 152a, 152b are locked to holding holes formed on the interconnect substrate.

A beryllium copper or the like having small resistance value and excellent durability is used as materials of the power supply springs 151a, 151b, 152a, 152b. In the embodiment, a coil spring obtained by winding a wire rod having excellent conductivity into a coil form is used as each of the power supply springs 151a, 151b, 152a, 152b.

In such a manner, the mirror actuator 100 is completely assembled as shown in FIG. 6B. If the assembled mirror actuator 100 is arranged such that the up-down direction as shown in FIG. 5 is parallel with the vertical direction, the supporting shaft 111 and the supporting shaft 125 are parallel with the left-right direction and the up-down direction as shown in FIG. 5, respectively and the mirror 140 faces to the front side.

Lengths, spring coefficients, and the like of the power supply springs 151a, 151b, 152a, 152b are set such that the mirror 140 of the mirror actuator 100 after assembled faces to the front side. Further, the power supply springs 151a, 151b, 152a, 152b are set so as to have expanding and contracting allowances in a allowable range where the mirror 140 rotates after the mirror actuator 100 is assembled.

Referring to FIG. 5 and FIGS. 6A and 6B, when the pan unit 120 rotates about the supporting shaft 125 with respect to the tilt unit 110, the mirror 140 rotates in accompanied therewith. Further, when the tilt unit 110 rotates about the supporting shaft 111 with respect to the magnet unit 130, the pan unit 120 rotates in accompanied with the rotation of the tilt unit 110 and the mirror 140 rotates integrally with the pan unit 120. Thus, the mirror 140 is rotatably supported by the supporting shafts 111, 125 which are perpendicular to each other and rotates about the supporting shafts 111, 125 by applying currents to the coils 115, 116, 124. At this time, the transparent body 200 attached to the pan unit 120 rotates in accompanied with the rotation of the mirror 140.

In the assembled state as shown in FIG. 6B, the eight magnets 134 are arranged and polarities thereof are adjusted such that a rotational force about the supporting axis 111 is generated on the tilt unit 110 by applying currents to the coils 115, 116 through the power supply springs 151a, 151b. Accordingly, if currents are applied to the coils 115, 116, the tilt unit 110 rotates about the supporting axis 111 with electromagnetic driving forces generated on the coils 115, 116.

Further, in the assembled state as shown in FIG. 6B, the two magnets 135 are arranged and polarities thereof are adjusted such that a rotational force about the supporting axis 125 is generated on the pan unit 120 by applying current to the coil 124. Accordingly, if current is applied to the coil 124, the pan unit 120 rotates about the supporting axis 125 with an electromagnetic driving force generated on the coil 124. Further, the transparent body 200 rotates in accompanied therewith.

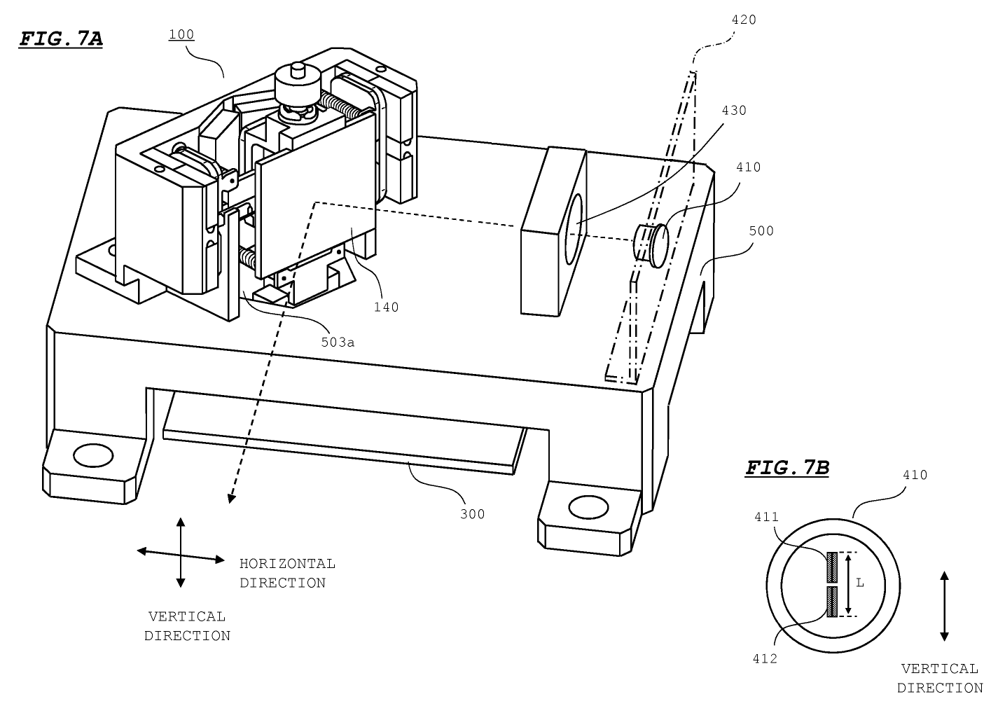

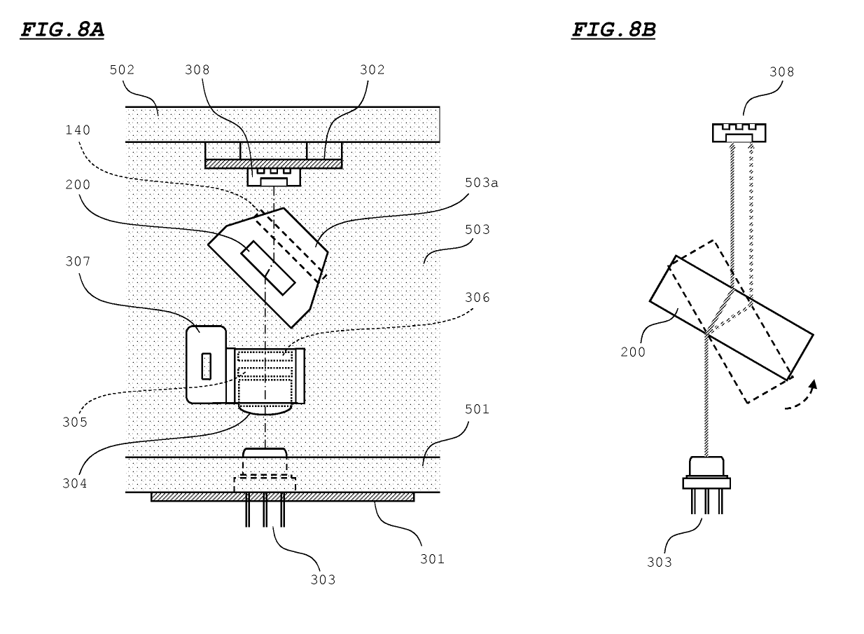

Next, the optical system of the beam irradiation apparatus is described with reference to FIGS. 7A, 7B, 8A and 8B.

A scanning optical system is described with reference to FIG. 7A, at first. In FIG. 7A, a reference numeral 500 corresponds to a base. In FIG. 7A, an upper face of the base 500 is horizontal. An opening 503a is formed on the base 500 at an arrangement position of the mirror actuator 100. The mirror actuator 100 is attached onto the base 500 such that the transparent body 200 is inserted to the opening 503a. The mirror actuator 100 is attached to the base 500 such that the up-down direction as shown in FIG. 5 corresponds to the vertical direction as shown in FIG. 7A.

A laser light source 410 and a convergent lens 430 are arranged on the upper face of the base 500. The laser light source 410 is attached to a substrate 420 for the laser light source. The substrate 420 is arranged on the upper face of the base 500. The laser light source 410 outputs a laser beam having a predetermined wavelength. The convergent lens 430 is a convex lens having a predetermined focal distance. A lens surface of the convergent lens 430 has a rotationally symmetric shape about an optical axis.

As schematically showing in FIG. 7B, two laser chips 411, 412 are arranged so as to be aligned in a CAN of the laser light source 410 such that pn junction surfaces are parallel with each other. The entire length L of the two laser chips 411, 412 in the direction parallel with the pn junction surfaces is adjusted such that the laser beam on the target region has a desired shape as described above with reference to FIG. 4C. The laser light source 410 is arranged such that these two laser chips 411, 412 are aligned in the vertical direction. Further, the two laser chips 411, 412 are positioned to be slightly close to the convergent lens 430 from a position of the focal distance of the convergent lens 430 such that the laser beam transmitted through the convergent lens 430 spreads in the horizontal direction by a predetermined angle.

Note that although the two laser chips 411, 412 are arranged in the CAN of the laser light source 410 here, three or more laser chips may be arranged in the CAN of the laser light source 410. In this case, the entire length L of the light emitting portion composed of these laser chips in the vertical direction is also adjusted such that the laser beam on the target region has a desired shape. As the other configuration, only one laser chip may be arranged in the CAN of the laser light source 410. In such a case, the length L of the laser chip (light emitting portion) in the vertical direction is adjusted such that the laser beam on the target region has a desired shape.

The laser beam (hereinafter, referred to as “scanning laser beam”) output from the laser light source 410 enters onto the convergent lens 430 not through a beam shaping lens or an aperture. The laser beam transmitted through the convergent lens 430 travels to the target region in a state where the laser beam is slightly diverged in the vertical direction and the horizontal direction such that the size of the laser beam becomes a predetermined size (for example, about 2 m long and about 1 m wide) on the target region. In this case, the target region is set to a position about 100 m ahead of the beam emitting port of the beam irradiation apparatus, for example.

The scanning laser beam transmitted through the convergent lens 430 enters into the mirror 140 of the mirror actuator 100 and is reflected by the mirror 140 toward the target region. The mirror 140 is biaxially driven by the mirror actuator 100 so that the scanning laser beam is scanned on the target region.

When the mirror 140 is at a neutral position, the mirror actuator 100 is arranged such that the scanning laser beam from the convergent lens 430 enters into a mirror surface of the mirror 140 at an incident angle of 45 degree in the horizontal direction. The expression “neutral position” indicates a position of the mirror 140 at which the mirror surface is parallel with the vertical direction and the scanning laser beam enters into the mirror surface at the incident angle of 45 degree with respect to the horizontal direction. The mirror 140 is positioned at the neutral position in a state where currents are not applied to the coils 115, 116, 124.

A circuit substrate 300 is arranged on a lower face of the base 500. Further, circuit substrates 301, 302 are arranged on a back face and a side face of the base 500, respectively.

FIG. 8A is a partial plan view when the base 500 is seen from the back face side. A servo optical system arranged on the back side of the base 500 and configurations peripheral to the servo optical system are illustrated in FIG. 8A.

As shown in FIG. 8A, walls 501, 502 are formed on back side edges of the base 500. A center portion between the walls 501, 502 corresponds to a flat face 503 which is lower than the walls 501, 502 by one step. An opening for attaching a laser diode 303 is formed on the wall 501. A circuit substrate 301 to which the laser diode 303 has been attached is attached to an outer face of the wall 501 in such a manner that the laser diode 303 is inserted into the opening. On the other hand, a circuit substrate 302 to which a PSD 308 has been attached is attached in the vicinity of the wall 502.

A condensing lens 304, an aperture 305, and a neutral density (ND) filter 306 are attached to the flat face 503 at the backside of the base 500 with an attachment 307. Further, the above opening 503a is formed on the flat face 503. The transparent body 200 attached to the mirror actuator 100 projects to the back side of the base 500 through the opening 503a. Here, when the mirror 140 of the mirror actuator 100 is at the neutral position, the transparent body 200 is positioned such that two flat faces are parallel with the vertical direction and are inclined at 45 degree with respect to the output light axis of the laser diode 303.

The laser beam (hereinafter, referred to as “servo beam”) output from the laser diode 303 is transmitted through the condensing lens 304. Then, a beam diameter thereof is restricted by the aperture 305. Further, the laser beam is extinguished by the ND filter 306. Then, the servo beam is entered into the transparent body 200 so as to be subjected to a refraction action by the transparent body 200. Thereafter, the servo beam transmitted through the transparent body 200 is received by the PSD 308 and a position detection signal in accordance with the light reception position is output from the PSD 308.

FIG. 8B is a view schematically illustrating a configuration in which a rotation position of the transparent body 200 is detected by the PSD 308. Note that only the transparent body 200, the laser diode 303 and the PSD 308 in FIG. 8A are illustrated in FIG. 8B for convenience of explanation.

The servo beam is refracted by the transparent body 200 arranged so as to be inclined with respect to the laser beam axis and received by the PSD 308. When the transparent body 200 is rotated as shown by a dashed line arrow, an optical path of the servo beam changes to a path as shown by a solid line from a path shown by the dotted line in FIG. 8B and a reception position of the servo beam on the PSD 308 changes. Therefore, a rotation position of the transparent body 200 can be detected by the reception position of the servo beam, which is detected by the PSD 308. The rotation position of the transparent body 200 corresponds to a scanning position of the scanning laser beam on the target region. Accordingly, the scanning position of the scanning laser beam on the target position can be detected based on a signal from the PSD 308.

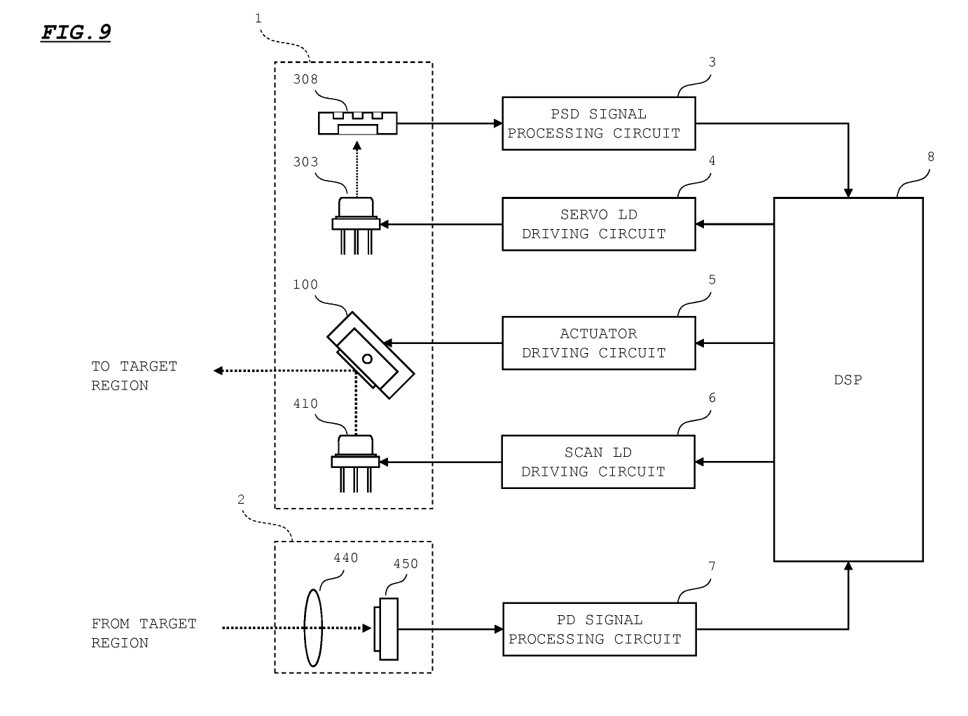

FIG. 9 is a view illustrating a configuration of a laser radar on which the beam irradiation apparatus having the above configuration is mounted. As shown in FIG. 9, the laser radar includes a beam irradiation apparatus 1 having the above configuration, a light reception portion 2, a PSD signal processing circuit 3, a servo LD driving circuit 4, an actuator driving circuit 5, a scan LD driving circuit 6, a PD signal processing circuit 7 and a DSP 8.

As the configurations in the beam irradiation apparatus 1, only the laser light source 410, the mirror actuator 100, the laser diode 303, and the PSD 308 are illustrated in FIG. 9 for convenience of explanation. The light reception portion 2 includes a condensing lens 440 which condenses a scanning laser beam reflected from the target region and a Photo Detector (PD) 450 which receives the condensed scanning laser beam.

The PSD signal processing circuit 3 generates a position detection signal from an output signal from the PSD 308 and outputs the generated signal to the DSP 8.

The servo LD driving circuit 4 supplies a driving signal to the laser diode 303 based on a signal from the DSP 8. To be more specific, when the beam irradiation apparatus 1 is operated, the servo beam having a constant output is output from the laser diode 303.

The actuator driving circuit 5 drives the mirror actuator 100 based on a signal from the DSP 8. To be more specific, a driving signal for making the scanning laser beam scan on the target region along a predetermined trajectory is supplied to the mirror actuator 100.

The scan LD driving circuit 6 supplies a driving signal to the laser light source 410 based on a signal from the DSP 8. To be more specific, the laser diode 303 pulse-emits at a timing where the scanning position of the scanning laser beam is at a predetermined position on the target region. That is to say, the laser beams are emitted from the two laser chips 411, 412 arranged in the laser light source 410 simultaneously at a timing where the scanning position reaches to the irradiation position as shown in FIG. 1.

The PD signal processing circuit 7 amplifies and digitalizes a signal from the PD 450 to supply the obtained signal to the DSP 8.

The DSP 8 detects a scanning position of the scanning laser beam on the target region based on the position detection signal input from the PSD signal processing circuit 3 so as to control driving of the mirror actuator 100, driving of the laser light source 410, and the like. Further, the DSP 8 judges whether an obstacle is present on the irradiation position with the scanning laser on the target region based on the signal input from the PD signal processing circuit 7. At the same time, the DSP 8 measures a distance to the obstacle based on a time difference between an irradiation timing of the scanning laser beam output from the laser light source 410 and a light reception timing of the reflected light from the target region, which is received on the PD 450.

According to the embodiment, the laser light source is arranged such that the pn junction surface of the laser chip is parallel with the vertical direction so that the divergence angle of the laser beam in the vertical direction can be easily adjusted. Additionally, the following effects can be obtained by aligning two laser chips 411, 412 in the vertical direction to adjust the entire length L of the light emitting portion as in the specific configuration example. That is, the beam diameter of the laser beam when the laser beam is entered into the convergence lens 430 is made smaller as described above with reference to FIGS. 4C and 4D so that affects by dusts, water drops, or the like adhering to the convergent lens 430 on the laser beam can be suppressed. Therefore, with this configuration, the target region can be appropriately irradiated with a laser beam, thereby enhancing detection accuracy of an obstacle on the target region.

Although the embodiment of the invention has been described above, the invention is not limited to the above embodiment. Further, the embodiment of the invention can variously modified into modes other than the above embodiment.

For example, in the above embodiment and specific configuration example, the divergence angle of the laser beam in the horizontal direction is adjusting by making the position of the laser chip close to the convergent lens from the position of the focal distance of the convergent lens. However, the divergence angle of the laser beam in the horizontal direction may be adjusted by adjusting length of the light emitting portion in the short side direction as in the longitudinal direction. In this case, the length of the light emitting portion in the short side direction can be adjusted by stacking the laser chips in the short side direction.

Further, all or a part of the PSD signal processing circuit 3, the servo LD driving circuit 4, an actuator driving circuit 5 and the scan LD driving circuit 6 in the configuration shown in FIG. 9 may be included as configurations in the beam irradiation apparatus 1.

In addition, the embodiment of the invention can be appropriately modified in a range of claims.

What is claimed is:

1. A beam irradiation apparatus comprising:
a light source which outputs a laser beam;
a convergent lens into which the laser beam output from the light source is entered; and
a scanning portion which makes the laser beam transmitted through the convergent lens scan on a target region, wherein
the laser light source is arranged such that a pn junction surface of a laser chip is parallel with the vertical direction, and
length of the laser beam in the vertical direction on the target region is set by length of a light emitting portion of the laser light source in the vertical direction.

2. The beam irradiation apparatus according to claim 1,
wherein the laser chip is arranged in the vicinity of a focal position of the convergent lens.

3. The beam irradiation apparatus according to claim 2,
wherein when length of the laser beam in the vertical direction on the target region is assumed to be a predetermined length, in a case where a divergence angle of the laser beam after the laser beam passes through the convergent lens is θ, length of the light emitting portion in the vertical direction is set such that a half value y of the length of the light emitting portion in the vertical direction is y=f·tan θ.

4. The beam irradiation apparatus according to claim 3,
wherein in the light source, the light emitting portion is configured by a plurality of laser chips which is arranged such that pn junction surfaces are parallel with the vertical direction.

5. The beam irradiation apparatus according to claim 4, further comprising a light source controller which controls the light source,
wherein the light source controller makes all of the plurality of laser chips emit light simultaneously when the target region is irradiated with the laser beam.

6. The beam irradiation apparatus according to claim 5,
wherein when length of the laser beam in the vertical direction on the target region is assumed to be a predetermined length, in a case where a divergence angle of the laser beam after the laser beam passes through the convergent lens is θ, the number of the laser chips aligned in the vertical direction is set such that a half value y of the length of the light emitting portion in the vertical direction is y=f·tan θ.

7. The beam irradiation apparatus according to claim 3,
wherein the laser chip is arranged at a position where the laser chip is made close to the convergent lens from the focal position of the convergent lens such that the laser beam on the target region has a predetermined width in the horizontal direction.

8. A beam irradiation apparatus comprising:
a light source in which a plurality of laser chips is arranged so as to be aligned in the vertical direction such that pn junction surfaces are parallel with the vertical direction;
a convergent lens into which the laser beam output from the light source is entered;
a scanning portion which makes the laser beam transmitted through the convergent lens scan on a target region; and
a light source controller which controls the light source,
wherein the light source controller makes all of the plurality of laser chips emit light simultaneously when the target region is irradiated with the laser light.

9. The beam irradiation apparatus according to claim 8,
wherein the laser chip is arranged in the vicinity of a focal position of the convergent lens.
